(19) United States
(12) Patent Application Publication
(10) Pub. No.: US 2009/0195803 A1
(43) Pub. Date: Aug. 6, 2009

(54) Image processing method, program thereof, and image processing apparatus

(75) Inventor: Masahiko Hirasawa, Sapporo-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/322,553

(22) Filed: Feb. 4, 2009

(30) Foreign Application Priority Data
Feb. 4, 2008 (JP) JP 2008-023825

(51) Int. Cl. H04N 1/60

(52) U.S. Cl. 358/1.9

(57) ABSTRACT

There is provided an image processing method for generating a bit map image of an object from a vector image by superimposing a plurality of parts by using a computer software program. The image processing method includes assigning unique identification information to a drawing command in a case where designation for transmission is included in the drawing command that is a command for drawing the object by using the plurality of parts, determining whether identification information that is assigned to a drawing position in which a drawing process is performed and the identification information that is assigned to the drawing command coincide with each other in a case where the drawing process is performed based on the drawing command to which the unique identification information is assigned, and assigning the identification information that is assigned to the drawing command to the drawing position and performing a drawing process for the drawing position on the basis of the drawing command, for a case where the identification information does not coincide with each other and not performing the drawing process for the drawing position on the basis of the drawing command for a case where the identification information coincide with each other.

The entire disclosure of Japanese Patent Application No. 2008-023825, filed Feb. 4, 2008 is expressly incorporated by reference herein.

### BACKGROUND

1. Technical Field

The present invention relates to an image processing method, a program thereof, and an image processing apparatus.

2. Related Art

As general image processing methods for drawing a diagram by approximating an object such as a curve by using a plurality of segments, methods in which a curve is divided finely for areas near contact points that are brought into contact with other lines forming a tangent line of the curve and is divided roughly for the other areas, and a drawing process is performed by approximating the divided curves by using straight lines have been proposed (for example, see JP-A-8-297747). According to the image processing method disclosed in JP-A-8-297747, an approximated curve and a tangent line thereof can be formed smoothly without incurring a decrease in the processing speed.

However, in drawing an object, the transmittance for transmitting the background may be set. As described above, in a case where the transmittance is set for an object, when the image processing method disclosed JP-A-8-297747 is performed, the transmittance is set for each straight line that is divided and approximated. Thus, for a part in which the straight lines are overlapped with each other, the transmittance is overlapped with each other, as well. Accordingly, the object to be drawn in one color may have different colors in a part in which the divided straight lines are overlapped with each other and a part in which the divided straight lines are not overlapped with each other. In order to avoid this, for example, a method in which an object, for which the transmittance is set for an area, is expanded in a non-transmission state, then, the object is transmitted, and the transmitted object is incorporated into an image may be considered. However, for a case where the process for drawing is complicated or there is a plurality of objects, there are disadvantages that the drawing speed is decreased and the like.

### SUMMARY

An advantage of some aspects of the invention is that it provides an image processing method, a program thereof, and an image processing apparatus capable of suppressing a decrease in the drawing speed and drawing with appropriate transmission in drawing an object by using a plurality of parts.

According to a first aspect of the invention, there is provided an image processing method for generating a bit map image of an object from a vector image by superimposing a plurality of parts by using a computer software program. The image processing method includes: (a) assigning unique identification information to a drawing command in a case where designation for transmission is included in the drawing command that is a command for drawing the object by using the plurality of parts; (b) determining whether identification information that is assigned to a drawing position in which a drawing process is performed and the identification information that is assigned to the drawing command coincide with each other in a case where the drawing process is performed based on the drawing command to which the unique identification information is assigned; and (c) assigning the identification information that is assigned to the drawing command to the drawing position and performing a drawing process for the drawing position based on the drawing command, for a case where the identification information does not coincide with each other and not performing the drawing process for the drawing position base on the drawing command for a case where the identification information coincide with each other.

According to the above-described image processing method, unique identification information is assigned to a drawing command in a case where designation for transmission is included in the drawing command that is a command for drawing the object by using the plurality of parts, and whether identification information that is assigned to a drawing position in which a drawing process is performed and the identification information that is assigned to the drawing command coincide with each other is determined in a case where the drawing process is performed based on the drawing command to which the unique identification information is assigned. Then, the identification information that is assigned to the drawing command is assigned to the drawing position and a drawing process for the drawing position is performed based on the drawing command, for a case where the identification information does not coincide with each other. On the other hand, the drawing process for the drawing position on the basis of the drawing command is not performed for a case where the identification information coincides with each other. As described above, when the object is drawn by superimposing a plurality of parts, unique identification information is assigned to a drawing part for a case where transmission is designated, and thereby transmitted parts are not drawn repeatedly for the parts having same identification information. Accordingly, for example, a decrease in the drawing speed can be suppressed, compared to a case where the object that is designated for transmission for an area thereof is expanded in a non-transmission state, then, this object is transmitted, and the transmitted object is incorporated into the image. In addition, a drawing process can be performed with appropriate transmission. Here, “the identification information coincides with each other” includes a complete coincidence. In addition, for example, for a case where a plurality of identification information is assigned to a drawing position or the like, partial coincidence of the plurality of identification information is included therein. At this moment, in a case where a drawing process is performed with the identification information, which is assigned to the drawing command, assigned to the drawing position in determining whether the identification information coincides with each other, the identification information may be assigned to the drawing area drawn by the drawing command.

In the above-described image processing method, the identification information may be assigned to brush information that is included in the drawing command in the assigning of the unique identification information to the drawing command. The brush information is the same within a same object, and thus, in such a case, a drawing process for an object that is transmitted more assuredly can be performed.

In addition, in the above-described image processing method, in a case where the drawing process for the drawing position is performed by assigning the identification information that is assigned to the drawing command to the drawing position, color information may be set to the drawing position, and simultaneously the identification information may be assigned to a layer different from that of the color information that is set in the drawing position, in determining whether the identification information coincides with each other. In such a case, the images can be uniformly handled as images for which transmission is not designated and images for which transmission is designated, and accordingly, the processing efficiency is improved.

In addition, in the above-described image processing method, in a case where the drawing process for the drawing position is performed based on the drawing command, the color information for the drawing position may be set based on the color information that is set currently in the drawing position and the color information that is set by the drawing command, and simultaneously transmittance of the drawing position may be set based on a transmittance value currently set in the drawing position and a transmittance value that is included in the designation for transmission of the drawing command, in determining whether the identification information coincides with each other. In addition, the image processing method may further include: (d) generating the bit map image based on the set color information and the set transmittance after all the drawing processes are completed. In such a case, the drawing process is repeated in a state in which the color of the next object is superimposed with that of the currently drawing object. Accordingly, the objects are not needed to be managed in a plurality of areas so as to reflect the transmittance for generating a bit map image. In addition, in such a case, for example, compared to a case where a bit map image is generated by expanding a plurality of objects for which the transmittance is set in a plurality of areas and superimposing the plurality of objects with the transmittance reflected, the storage area can be reduced, and the decrease in the drawing speed can be suppressed.

According to a second aspect of the invention, there is provided a program for allowing one or more computers to execute steps of the above-described image processing method. This program may be recorded in a computer-readable recording medium (for example, a hard disk, a ROM, an FD, a CD, a DVD, or the like) or may be transferred from a computer to another computer through a transmission medium (a communication network such as the Internet or a LAN). Furthermore, the program may be transferred in any other form. When this program is executed in one computer or is executed in a plurality of computers with the steps divided therein, the steps of the above-described image processing method are performed, and accordingly, the same advantages as those of this image processing method can be acquired.

According to a third aspect of the invention, there is provided an image processing apparatus that generates a bit map image of an object from a vector image by superimposing a plurality of parts. The image processing apparatus includes: an identification information assigning unit that assigns unique identification information to a drawing command in a case where designation for transmission is included in the drawing command that is a command for drawing the object by using the plurality of parts; a determination unit that determines whether identification information that is assigned to a drawing position in which a drawing process is performed and the identification information that is assigned to the drawing command coincide with each other in a case where the drawing process is performed based on the drawing command to which the unique identification information is assigned; and a drawing unit that assigns the identification information that is assigned to the drawing command to the drawing position and performs the drawing process for the drawing position based on the drawing command, for a case where the identification information does not coincide with each other and does not perform the drawing process for the drawing position based on the drawing command for a case where the identification information coincide with each other.

According to the above-described image processing apparatus, unique identification information is assigned to a drawing command in a case where designation for transmission is included in the drawing command that is a command for drawing the object by using the plurality of parts, and whether identification information that is assigned to a drawing position in which a drawing process is performed and the identification information that is assigned to the drawing command coincide with each other is determined in a case where the drawing process is performed based on the drawing command to which the unique identification information is assigned. Then, the identification information that is assigned to the drawing command is assigned to the drawing position and a drawing process for the drawing position is performed based on the drawing command, for a case where the identification information does not coincide with each other. On the other hand, the drawing process for the drawing position on the basis of the drawing command is not performed for a case where the identification information coincides with each other. As described above, when the object is drawn by superimposing a plurality of parts, unique identification information is assigned to a drawing part for a case where transmission is designated, and thereby transmitted parts are not drawn repeatedly for parts having same identification information. Accordingly, for example, a decrease in the drawing speed can be suppressed, compared to a case where the object that is designated for transmission for an area thereof is expanded in a non-transmission state, then, this object is transmitted, and the transmitted object is incorporated into the image. In addition, a drawing process can be performed with appropriate transmission. In addition, in the above-described image processing apparatus, various steps of the above-described image processing methods may be performed.

In the above-described image processing apparatus, in a case where the drawing process for the drawing position is performed based on the drawing command, the drawing unit may set the color information for the drawing position based on the color information that is set currently in the drawing position and the color information that is set by the drawing command, simultaneously set transmittance of the drawing position based on a transmittance value currently set in the drawing position and a transmittance value that is included in the designation for transmission of the drawing command, and generate the bit map image based on the set color information and the set transmittance after all the drawing processes are completed. In such a case, the drawing process is repeated in a state in which the color of the next object is superimposed with that of the currently drawing object. Accordingly, the objects are not needed to be managed in a plurality of areas so as to reflect the transmittance for generating a bit map image. In addition, in such a case, the storage area can be reduced, and the decrease in the drawing speed can be suppressed.

### BRIEF DESCRIPTION OF THE DRAWINGS

The invention will be described with reference to the accompanying drawings, wherein like numbers reference like elements.

FIG. 1 is a schematic diagram showing the configuration of a printer 20 according to an embodiment of the invention.

FIG. 2 is a flowchart showing an example of a routine for managing drawing according to an embodiment of the invention.

FIG. 3 is an explanatory diagram showing an example of a drawing list 50 according to an embodiment of the invention that is stored in a RAM 24.

FIG. 4 is a diagram showing the concept of assigning a brush ID to the drawing list 50.

FIG. 5 is a flowchart showing an example of a routine for drawing a transmitted image according to an embodiment of the invention.

FIG. 6 is a diagram showing the concept of a drawing process for associating transmittance and a brush ID with each other according to an embodiment of the invention.

FIG. 7 is an explanatory diagram showing an example of a process for drawing a transmitted object according to an embodiment of the invention.

### DESCRIPTION OF EXEMPLARY EMBODIMENTS

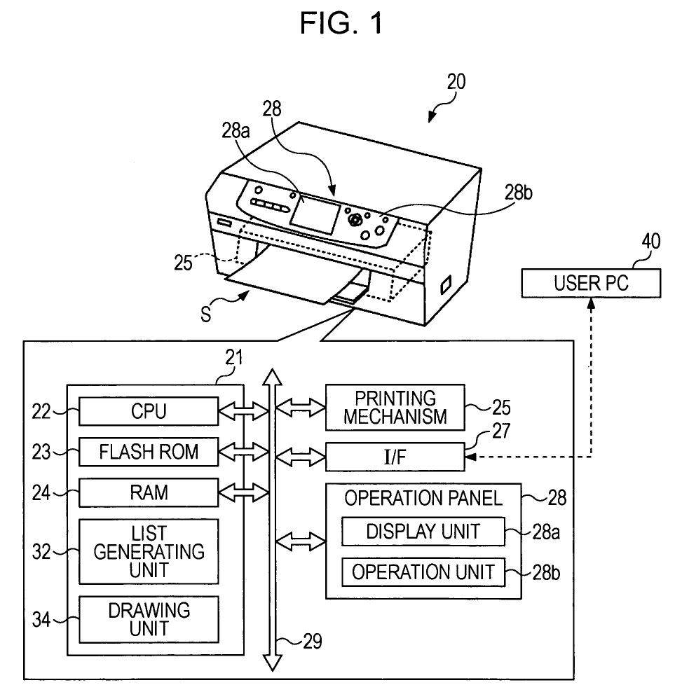

Next, a preferred embodiment of the invention will be described with reference to the accompanying drawings. FIG. 1 is a schematic diagram showing the configuration of a printer 20 according to an embodiment of the invention. The printer 20 includes a controller 21 that is responsible for control of the entire apparatus, a printing mechanism 25 that prints an image on a recording sheet S, an interface (I/F) 27 that can input or output information to or from a connected external device (for example, a user PC 40), and an operation panel 28 that can display information to a user and can receive a direction as an input from a user. The controller 21, the printing mechanism 25, the I/F 27, and the operation panel 28 are interconnected electrically through a bus 29. The controller 21 is configured by a microprocessor that has a CPU 22 as its central element. In addition, the controller 21 includes a flash ROM 23, of which data can be stored and erased, storing various application programs and various types of data files and a RAM 24 that temporarily stores data. In the RAM 24, a receiving buffer, not shown in the figure, that temporarily stores a file of a print job or the like input through the I/F 27 is configured. This controller 21, for example, includes a list generating unit 32 that has a function for analyzing, for example, a drawing command of an XPS (XML Paper Specification) and generating a drawing list, a drawing unit 34 that generates a bit map image from a vector image based on the generated drawing list, and the like. The printing mechanism 25, although not shown in the figure, is an ink jet mechanism that performs a printing process by applying pressure to ink of each color and injecting the pressed ink onto a recording sheet S. In addition, a mechanism that is used for applying the pressure to the ink may use deformation of a piezoelectric element or generation of air bubbles on the basis of heat of a heater. The operation panel 28 is a device that is for a user to input various commands to the printer 20. In the operation panel 28, a display unit 28a that is configured by a color liquid crystal panel in which a text and an image corresponding to the various commands are displayed and an operation unit 28b to which a user's command can be input are disposed.

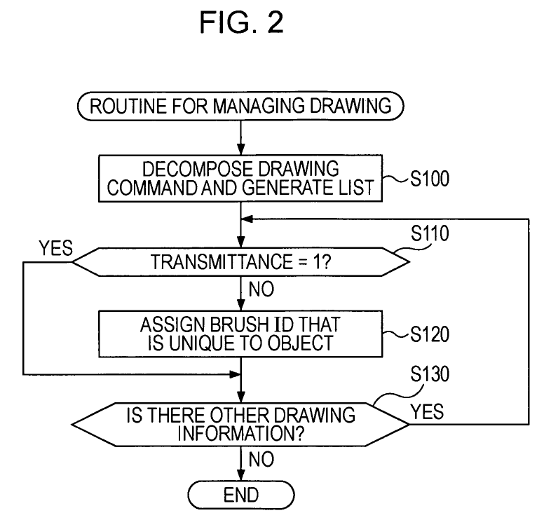

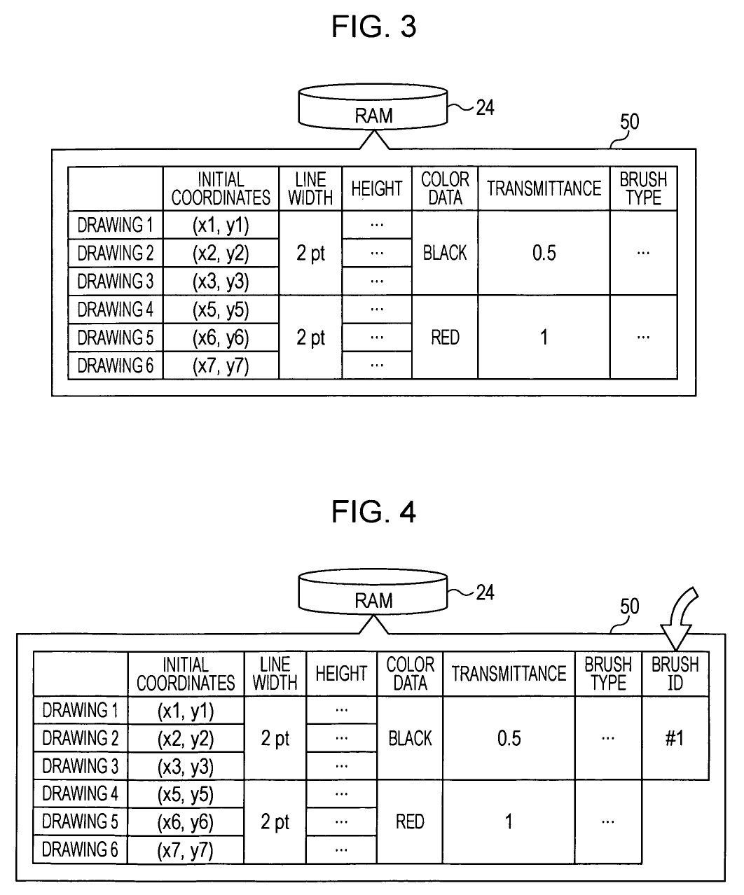

Next, the operations of the printer 20 according to this embodiment that is configured as above will be described, and first, the operation for forming a state in which the drawing command of the XPS can be executed will be described. FIG. 2 is a flowchart showing one example of a routine for managing drawing. This routine is stored in the flash ROM 23 and is executed after the drawing command of the XPS that is input from the user PC 40 through the I/F 27 is received. In addition, this routine for managing drawing is executed by the CPU 22 of the controller 21 by using the list generating unit 32. When this routine is executed, the CPU 22, first, decomposes the drawing command, which is described in the XPS and is sequentially transmitted, into drawing information for drawing a rectangle, sorts the drawing information in a predetermined order (for example, in the order of coordinates of axis Y) for drawing at a high speed, and stores the drawing information in a predetermined area of the RAM 24 as a drawing list 50 (Step S100). FIG. 3 is an explanatory diagram showing an example of the drawing list 50 that is stored in the RAM 24. In this drawing list 50, shape information such as initial coordinates, a line width, a height, and the like, and brush information such as RGB values of a color for painting, a transmittance value A, and a brush type that is a painting pattern are stored in each drawing information.

When the drawing list 50 is generated, the CPU 22 determines whether the transmittance value included in the drawing information is “1” (Step S110). When the transmittance value is not “1”, that is, when this part is to be drawn to be transmitted, a brush ID that is unique to each object is assigned to the drawing information (Step S120). At this moment, the brush information of a plurality of parts constituting an object is common to the object. Thus, the brush ID that is an identifier unique to the brush information of each drawing information is configured to be assigned to the brush information of each drawing information, so that drawing of a different object can be determined for a case where the brush ID is changed. FIG. 4 is a diagram showing the concept of assigning the brush IDs to the drawing list 50. Here, it is configured that the brush ID is assigned to each object as a unique number. On the other hand, when the transmittance value is “1” in Step S110, it is configured that the process for assigning the brush ID and the like is not performed.

After Step S120 or when the transmittance value is “1” in Step S110, it is determined whether there is other drawing information that has not been processed (Step S130). When there is other drawing information, the CPU 22 repeats the processes of Step S110 and thereafter. On the other hand, when there is no other drawing information that has not been processed in Step S130, this routine is stopped. As described above, relating to a drawing command for transmitted drawing, a unique brush ID is assigned to the drawing command that represents an object.

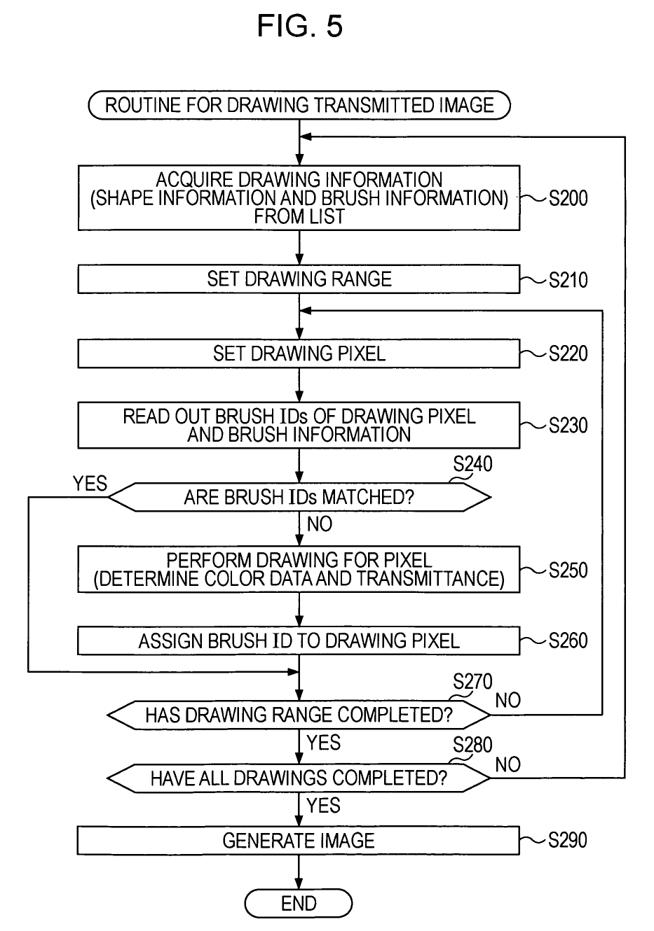

Subsequently, the process for generating a bit map image from a vector image by executing a drawing command will be described. FIG. 5 is a flowchart showing an example of a routine for performing transmitted image drawing. This routine is stored in the flash ROM 23. The routine is executed after the routine for managing drawing, only when the object to be drawn is for transmitted drawing, that is, when the transmittance value of the drawing command is smaller than “1”. In addition, the routine for performing the transmitted image drawing is performed by the CPU 22 of the controller 21 by using the drawing unit 34. When this routine is executed, the CPU 22, first, acquires the drawing information (the shape information and the brush information) from the drawing list 50 (Step S200). Here, the drawing information is configured to be sequentially acquired, started from the drawing information located in the leading position of the drawing list 50. Next, by using information of the initial position, the line width, and the like that is included in the shape information, a range for drawing on the basis of the drawing information, that is, an area of one part of the object is set (Step S210), and a drawing pixel as a drawing position for drawing is set (Step S220). The setting of the drawing pixel may be sequentially set, for example, from the initial coordinate side toward the final coordinate side.

Next, the CPU 22 reads out a brush ID that is assigned to the set drawing pixel and a brush ID that is assigned to drawing information to be drawn (Step S230), and it is determined whether the brush IDs match each other (Step S240). Here, the brush ID set to the brush information of the drawing information is assigned to the range for drawing an object to be transmitted, which will be described later in detail. When the brush ID is not assigned to the drawing pixel, it is configured that negative determination is made in Step S240. A plurality of brush IDs may be assigned to a pixel, as in a case where the plurality of objects designated for transmission is superimposed or the like. However, here, it is configured to be positively determined in Step S240 when any one of the plurality of brush IDs of the drawing pixel side matches the brush ID of the drawing information side.

When the brush IDs are determined not to match each other in Step S240, a part already drawn is regarded to be different from the object to be drawn, and a drawing process for the drawing pixel is performed by setting the color data and transmittance based on the drawing information (Step S250). Here, the drawing process is performed by setting the color data of the drawing pixel based on the color data currently set in the drawing pixel and the color data included in the drawing information and setting the transmittance of the drawing pixel based on the transmittance value currently set in the drawing pixel and the transmittance value included in the drawing information. This setting of the color data is performed by using a numeric equation that is determined in advance for forming an appropriate color by superimposing the objects. In addition, the setting of the transmittance is performed by multiplying the currently set transmittance value and the transmittance value included in the drawing information. As described above, by painting the drawing range in a superimposing manner, for example, individual generation and management of a sheet of each object are omitted.

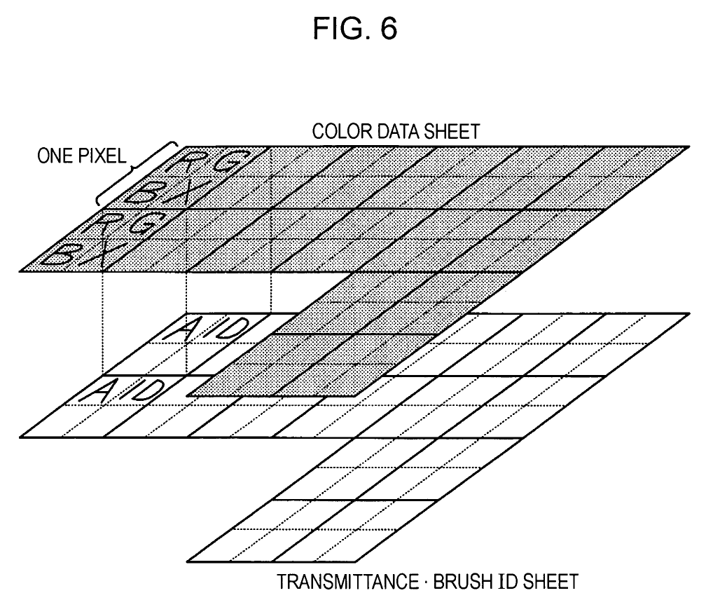

Next, the CPU 22 assigns the brush ID, which is unique to an object, that is assigned to the drawing information to the drawn pixel (Step S260). FIG. 6 is a diagram showing the concept of a drawing process for associating the transmittance and the brush ID with each other. As shown in FIG. 6, here, the transmittance value A and the value of the brush ID are stored in a different sheet that can be superimposed with the sheet of the color data. Here, in one pixel, the color data is stored in units of four bytes of values of R, G, and B and information value X on the image (for example, a text, a photograph, or the like). Accordingly, a sheet in which the color data is included can be handled in a same manner as that for an image in which an object to be transmitted is not included.

On the other, when the brush IDs are determined to match each other in Step S240, this drawing pixel is regarded as a part of a series of parts that constitute the object to be drawn. Thus, the drawing process is not performed for this drawing pixel, and processes of Step S270 and thereafter are performed. Accordingly, in drawing an object to be transmitted, performing a process of transmitting the parts in a superimposing manner in an area, in which the parts are overlapped each other, can be prevented.

After Step S260 or the brush IDs are determined to match each other in Step S240, the CPU 22 determines whether all the drawing processes for the drawing range are completed (Step S270). When the drawing processes are not completed, the processes of Step S220 and thereafter are repeated. On the other hand, when the drawing processes are completed, the CPU 22 determines whether the drawing processes for all the drawing information are completed (Step S280). When all the drawing processes for all the drawing information are not completed, the processes of Step S200 and thereafter are performed. On the other hand, when all the drawing processes for the all drawing information are completed, a bit map image is generated by reflecting the transmittance in the color information of each pixel (Step S290), and then, this routine is completed.

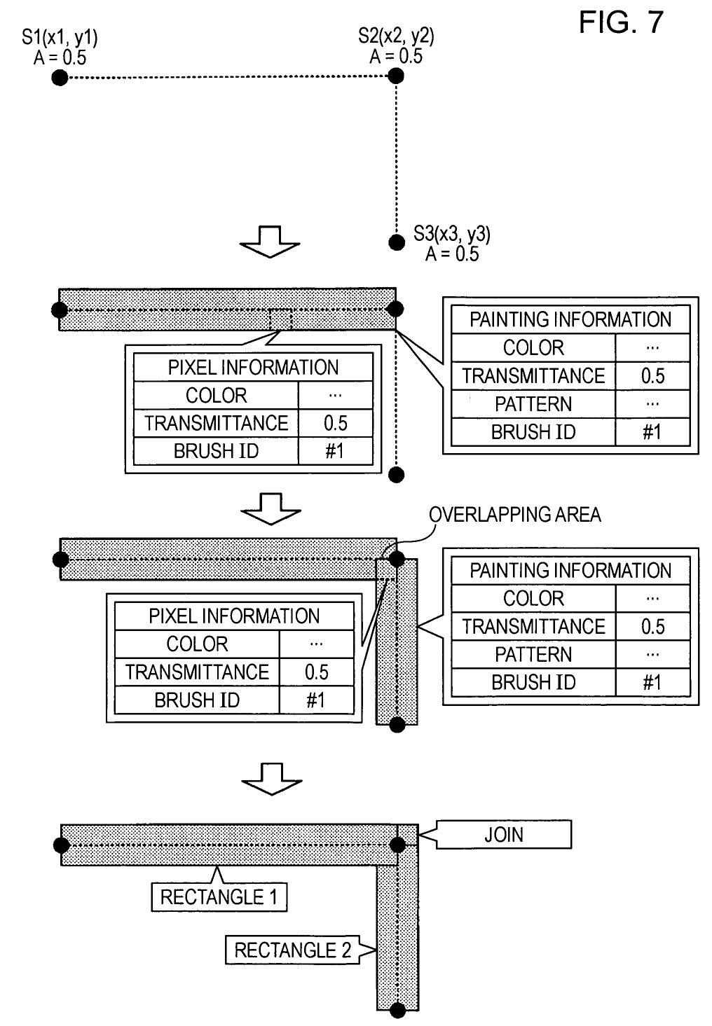

Here, the process for drawing an object to be transmitted will be described in detail with reference to FIG. 7. FIG. 7 is an explanatory diagram showing an example of a drawing process for an object to be transmitted. Here, a case where an “L”-shaped object acquired by superimposing rectangular parts is generated will be described. This object is designated for transmission and is drawn in accordance with a drawing command that includes drawing information for drawing a rectangular 1 at the initial coordinates S1 (x1,y1) to coordinates S2 (x2,y2), drawing information for drawing a rectangular 2 at the coordinates S2 to coordinates S2 (x3,y3), and drawing information for drawing join of the rectangular 1 and the rectangular 2. In descriptions below, step numbers of the above-described routine for managing drawing and the routine for performing drawing a transmitted image will be added. When receiving this drawing command, transmission is designated, and accordingly, the CPU 22 of the printer 20 assigns brush IDs to the brush information of each included drawing information (S120). Subsequently, an area of the coordinates S1 to the coordinates S2 is set as a drawing range with a designated line width (S210), and the drawing pixels are set (S220). Then, it is determined whether the brush IDs of the drawing pixels and the brush ID of the drawing information (drawing command) coincide with each other (S240). Here, since a same brush ID is not set, all the drawing processes for the rectangle 1 are performed (S250), and a brush ID is assigned to each drawing pixel (S260, see the second stage in FIG. 7). When a drawing process for the rectangle 1 is completed, a drawing process for the rectangle 2 is performed. At this moment, in an overlapped area between the rectangle 1 and the rectangle 2, the brushes IDs coincide with each other, and accordingly, the drawing process for the rectangle 2 is not performed. Then, the drawing process for the join thereof is performed, and whereby a drawing process for an object is performed.

The bit map image that is acquired by performing the above-described drawing process is used for a printing process performed by the printing mechanism 25 or is resized for being used for a display process in the display unit 28a or the like. In addition, although the drawing process for the object to be transmitted is described here, in order to draw an object not to be transmitted, it is preferable that the above-described processes are performed with Steps S230, S240, and S260 of the above-described routine for performing transmitted image drawing omitted.

Here, relationship between constituent elements of this embodiment and constituent elements of the invention will be described clearly. Step S120 of the routine for managing drawing that is performed by the printer 20 according to this embodiment corresponds to Step (a) of the invention, and Step S240 of the routine for performing transmitted image drawing corresponds to Step (b), Steps S240 and S250 correspond to Step (c), and Step S290 corresponds to Step (d). In addition, the controller 21 according to this embodiment corresponds to the identification information assigning unit, the determination unit, and the drawing unit, and the brush ID corresponds to unique identification information.

In the printer 20 according to this embodiment that has been described in detail as above, when designation for transmission is included in a drawing command that is a command for drawing an object by using a plurality of parts, a unique brush ID is assigned to this drawing command. When a drawing process is performed based on the drawing command to which this brush ID is assigned, it is determined whether the brush ID assigned to the drawing pixel for which the drawing process is performed and the brush ID assigned to this drawing command coincide with each other. When the brush IDs do not coincide with each other, the brush ID of the drawing command side is assigned to the drawing pixel, and the drawing process is performed. On the other hand, when the brush IDS coincide with each other, the drawing process for the drawing pixel on the basis of this drawing command is not performed. As described above, in a case where the object is drawn by superimposing a plurality of parts, when transmission is designated, a brush ID is assigned to a drawing part, and for parts having a same brush ID, the transmitted part is not drawn in a superimposing manner. Accordingly, a decrease in the drawing speed can be suppressed, and the drawing process can be performed with appropriate transmission, compared to a case where the object designated for transmission is expanded in a non-transmission state in an area, then, the object is transmitted, and incorporating the transmitted object into an image. In addition, since the brush ID is assigned to the brush information that is changed by the object, a drawing process for an object that is transmitted more assuredly can be performed. Moreover, in the drawing process, the brush ID is assigned to a separate layer (sheet) different from that of the color data. Accordingly, in an image, objects designated for transmission and objects designated for non-transmission can be handled uniformly, and thereby the processing efficiency is high. Furthermore, in the drawing process, a process for superimposing the color data and the transmittance of the drawing pixel is performed. Accordingly, by omitting managing the object in a plurality of sheets, a decrease of the storage area such as the RAM 24 can be achieved, and a decrease in the drawing speed can be suppressed, compared to a case where the bit map image is generated by expanding, for example, a plurality of objects for which the transmittance is set in a plurality of sheets and joining the plurality of objects in a superimposing manner with the transmittance reflected.

The invention is not limited to the above-described embodiment at all. In addition, it is apparent that the invention may be performed in various forms as long as it belongs to the technical scope of the invention.

For example, in the above-described embodiment, the brush ID is assigned to the brush information. However, the invention is not limited thereto, and it is preferable that the brush ID is assigned to the drawing information. In addition, in the above-described embodiment, the brush ID is assigned to the drawing pixel. However, the invention is not limited thereto. Thus, the brush ID may be assigned to the drawing range. In addition, in this point, assignment of the brush ID to the drawing pixel does not mean that a case where the brush IDs are assigned to the entire drawing range is excluded.

In the above-described embodiment, the brush ID is configured to be stored in a sheet that is different from the sheet of the color data. However, the invention is not limited thereto. Thus, it may be configured that the brush ID is stored in a same sheet as that of the color data.

In the above-described embodiment, the printer 20 has been described as an image processing apparatus according to an embodiment of the invention. However, the invention is not limited thereto as long as the image processing apparatus generates a bit map image of an object to be transmitted from a vector image by superimposing a plurality of parts. For example, the invention may be applied to a multiple function printer including a scanner, a printing apparatus such as a facsimile machine, or the user PC 40. In addition, the invention may be applied to an electronic apparatuses such as a cellular phone or a game device. In addition, the form of the printer 20 has been described as an image processing apparatus and an image processing method. However, a form of a program for performing the method may be implemented.

What is claimed is:

1. An image processing method for generating a bit map image of an object from a vector image, the image processing method comprising:
(a) assigning unique identification information to a drawing command in a case where designation for transmission is included in the drawing command that is a command for drawing the object by using a plurality of parts;
(b) determining whether identification information that is assigned to a drawing position in which a drawing process is performed and the identification information that is assigned to the drawing command coincide with each other in a case where the drawing process is performed based on the drawing command to which the unique identification information is assigned; and
(c) assigning the identification information that is assigned to the drawing command to the drawing position and performing a drawing process for the drawing position on the basis of the drawing command, for a case where the identification information does not coincide with each other and not performing the drawing process for the drawing position on the basis of the drawing command for a case where the identification information coincide with each other.

2. The image processing method according to claim 1, wherein the identification information is assigned to brush information that is included in the drawing command in the assigning of the unique identification information to the drawing command.

3. The image processing method according to claim 1, wherein, in a case where the drawing process for the drawing position is performed by assigning the identification information that is assigned to the drawing command to the drawing position, color information is set to the drawing position, and simultaneously the identification information is assigned to a layer different from that of the color information that is set in the drawing position, in determining whether the identification information coincides with each other.

4. The image processing method according to claim 1, wherein, in a case where the drawing process for the drawing position is performed based on the drawing command, the color information for the drawing position is set based on the color information that is set currently in the drawing position and the color information that is set by the drawing command, and simultaneously transmittance of the drawing position is set based on a transmittance value currently set in the drawing position and a transmittance value that is included in the designation for transmission of the drawing command, in determining whether the identification information coincides with each other,
the image processing method further comprising:
(d) generating the bit map image based on the set color information and the set transmittance after all the drawing processes are completed.

5. A recording medium, having a program for allowing one or more computers to execute steps of the image processing method according to claim 1.

6. An image processing apparatus that generates a bit map image of an object from a vector image, the image processing apparatus comprising:
an identification information assigning unit that assigns unique identification information to a drawing command in a case where designation for transmission is included in the drawing command that is a command for drawing the object by using a plurality of parts;
a determination unit that determines whether identification information that is assigned to a drawing position in which a drawing process is performed and the identification information that is assigned to the drawing command coincide with each other in a case where the drawing process is performed based on the drawing command to which the unique identification information is assigned; and
a drawing unit that assigns the identification information that is assigned to the drawing command to the drawing position and performs the drawing process for the drawing position on the basis of the drawing command, for a case where the identification information does not coincide with each other and does not perform the drawing process for the drawing position on the basis of the drawing command for a case where the identification information coincide with each other.

7. The image processing apparatus according to claim 6, wherein, in a case where the drawing process for the drawing position is performed based on the drawing command, the drawing unit sets the color information for the drawing position based on the color information that is set currently in the drawing position and the color information that is set by the drawing command, simultaneously sets transmittance of the drawing position based on a transmittance value currently set in the drawing position and a transmittance value that is included in the designation for transmission of the drawing command, and generates the bit map image based on the set color information and the set transmittance after all the drawing processes are completed.
